(19) United States
(12) Patent Application Publication
(10) Pub. No.: US 2025/0368042 A1
(43) Pub. Date: Dec. 4, 2025

(54) NOTIFICATION MANAGEMENT FOR VEHICLES

(71) Applicant: FCA US LLC, Auburn Hills, MI (US)

(72) Inventors: Pravin Vishwasrao Chopade, Troy, MI (US); Amit Mehta, Troy, MI (US); Gyanesh Shrivastava, Troy, MI (US); Ashish Bansal, Northville, MI (US)

(21) Appl. No.: 18/679,927

(22) Filed: May 31, 2024

(51) Int. Cl. B60K 35/28

(52) U.S. Cl. CPC B60K 35/28; B60K 2360/167; B60K 2360/186

(57) ABSTRACT

A method for managing notifications to a user, includes receiving at a backend portion information relating to multiple notifications, determining a base importance rating for one or more of the multiple notifications, categorizing the notifications into multiple content classes based at least in part on the content of the notifications, receiving at the backend portion context relevant information, determining an adjusted importance rating for the one or more of the multiple notifications as a function of the base importance rating, class and context relevant information, and providing a notification from the backend portion when the adjusted importance rating satisfies an importance threshold that is based on at least part of the context relevant information.

### FIELD

The present disclosure relates to systems and methods for managing notifications in vehicles for vehicle occupants.

### BACKGROUND

Modern vehicles increasingly include software applications, including internet interfaces and in-vehicle web applications, as well as an increasing number of electronic devices. Thus, vehicle drivers are faced with a growing array of distractions, and drivers often find themselves frustrated by the distractions and inundated with alerts and notices that are not important to the driver or arrive at an inconvenient time or at a time that is not relevant to the content of the alert or notice or to the current context of vehicle use.

### SUMMARY

In at least some implementations, a method for managing notifications to a user, includes receiving at a backend portion information relating to multiple notifications, determining a base importance rating for one or more of the multiple notifications, categorizing the notifications into multiple content classes based at least in part on the content of the notifications, receiving at the backend portion context relevant information, determining an adjusted importance rating for the one or more of the multiple notifications as a function of the base importance rating, class and context relevant information, and providing a notification from the backend portion when the adjusted importance rating satisfies an importance threshold that is based on at least part of the context relevant information.

In at least some implementations, the base importance rating includes multiple levels of importance by which a relative importance of different ones of the multiple notifications can be determined.

In at least some implementations, the adjusted importance rating includes multiple levels of importance by which a relative importance of different ones of the multiple notifications can be determined.

In at least some implementations, the context relevant information includes one or more of current vehicle operating conditions, vehicle location, weather at or near the vehicle location, time and one or more user preferences. In at least some implementations, the current vehicle operating conditions includes one or more of a vehicle speed, acceleration and type of road on which the vehicle is located. In at least some implementations, the current vehicle operating conditions includes data from one or more vehicle sensors.

In at least some implementations, the method also includes receiving at the backend portion information about one or more environmental conditions.

In at least some implementations, the importance rating is determined and/or the categorizing step is accomplished with a gradient boosting matrix.

In at least some implementations, the adjusted importance rating is determined with a rules-based model that changes the base importance rating in accordance with rules for multiple variables. and a reinforcement learning model.

In at least some implementations, the adjusted importance rating is determined with a reinforcement learning model that defines a reward function and based at least in part on an estimated value of taking a first action in a first state compared to the reward from taking the first action in the first state.

In at least some implementations, a system of a vehicle for managing notifications to a user of the vehicle, includes one or more vehicle sensors, a control system that includes a data storage unit and an electronic control unit, the control system being in communication with the one or more vehicle sensors, a communications unit that is communicated with the control system and that has a receiver by which information is received at a network vehicle and a transmitter by which information is transmitted from the network vehicle, and a backend portion of a cloud-based system. The backend portion includes a processor and memory with programming to:
receive at a backend portion information relating to multiple notifications;
determine a base importance rating for one or more of the multiple notifications;
categorize the notifications into multiple content classes based at least in part on the content of the notifications;
receive at the backend portion context relevant information;
determine an adjusted importance rating for the one or more of the multiple notifications as a function of the base importance rating, class and context relevant information;
determine an importance threshold based on at least part of the context relevant information; and
provide a notification from the backend portion when the adjusted importance rating satisfies the importance threshold.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a system for determining customized recommendations for a vehicle user;

FIG. 2 is a diagrammatic view of a vehicle that defines part of the system;

FIG. 3 is a diagrammatic view of a vehicle control system which may define part of a frontend portion of the system;

FIGS. 4-6 are representative screenshots from the display of an in-vehicle infotainment system that may define part of the frontend portion of the system;

FIG. 7 is a flowchart of a method for managing notifications to a vehicle user; and

FIG. 8 is a diagrammatic view of information sources and programs of the system.

### DETAILED DESCRIPTION

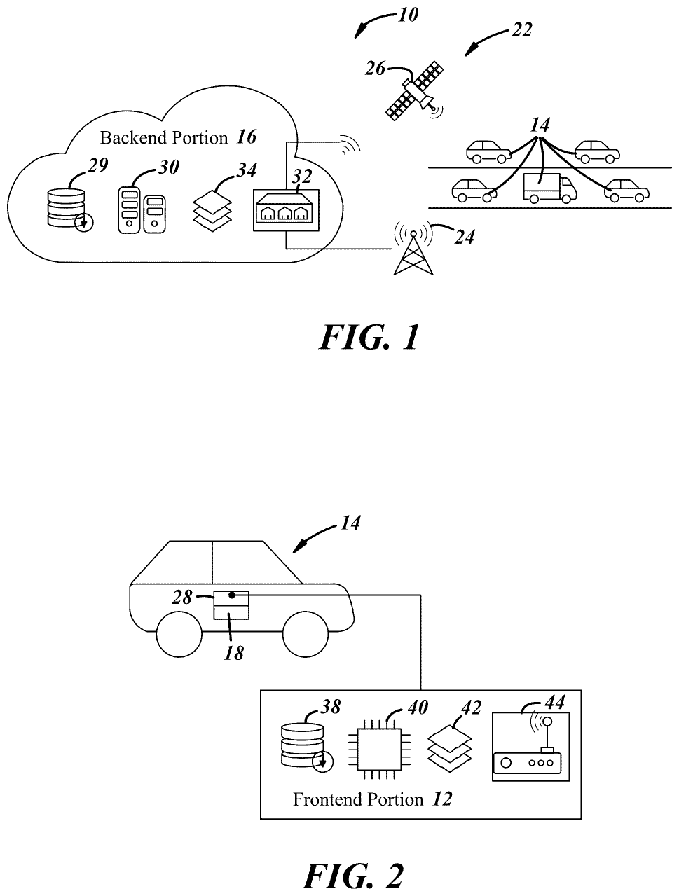

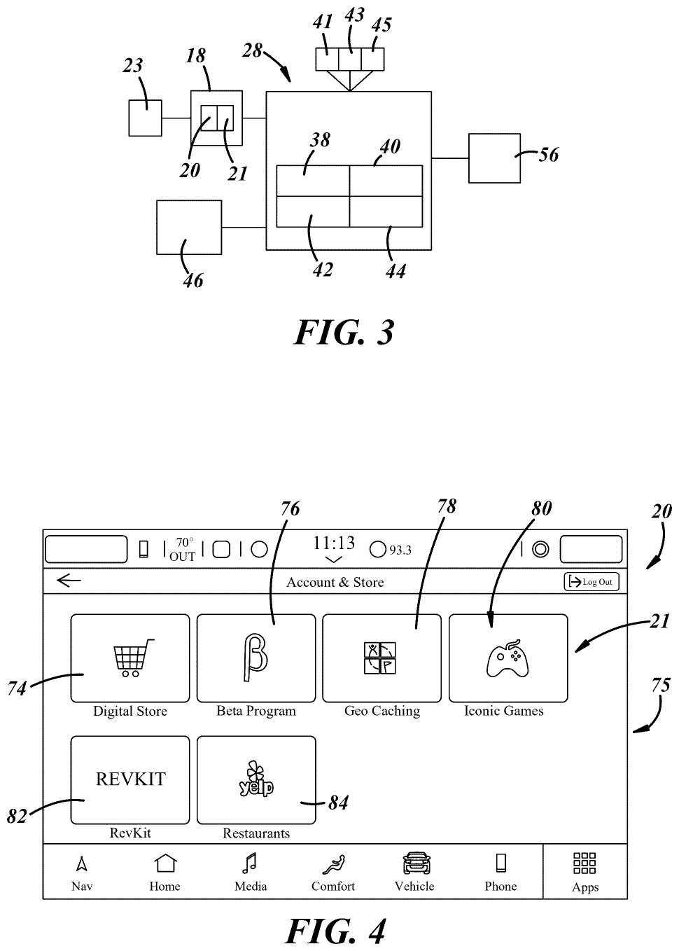

Referring in more detail to the drawings, FIG. 1 illustrates a vehicle information system 10 including a frontend portion 12 with one or more network vehicles 14 that are in communication with a backend portion 16 via one or more communication devices and suitable communication protocols. The network vehicles include in-vehicle infotainment (IVI) systems 18 (FIGS. 3 and 4) that utilize a combination of software and hardware components to provide a wide range of information, system controls and entertainment. As diagrammatically shown in FIGS. 3 and 4, the IVI system 18 may include one or more display screens 20 and a user interface 21. As described herein, the information system 10 utilizes a wide range of data and parameters to provide context relevant communications to a user 23 (FIG. 4) of a vehicle.

With reference to the schematic block diagrams in FIGS. 1 and 2, the vehicle information system 10 may be a cloud-based system that may receive incoming information from individual ones of the network vehicles 14 and send outgoing information to multiple network vehicles 14, where the outgoing information may include mass communications (i.e. notifications) that are the same for multiple vehicles or individual communications that are each specific to the vehicle to which each individual communication is sent. The system 10 may gather real-time information from network vehicles 14, and the system 10 may analyze the information and determine if a notification should be sent to one or more vehicles as noted in more detail later

The term “real-time”, as used herein, does not strictly require that such information and notifications be generated, sent, received and/or otherwise processed at the exact moment when their underlying events or conditions occur in order to be “real-time”. Rather, these terms broadly include any such information and notifications that are generally contemporaneous with their underlying events or conditions so that the environmental conditions information and notifications are still relevant or accurate in the context of the present system and method (e.g., within seconds, minutes or even hours of their underlying events or conditions).

System 10 may deliver hosted services via the internet and/or other communication networks and may be structured as a public, private or hybrid cloud, for example. According to one non-limiting example, vehicle information system 10 is structured as a private cloud and generally includes the backend portion 16 and the frontend portion 12 that is distributed across a fleet of network vehicles 14, where each network vehicle 14 is capable of obtaining and providing information as well as communicating with the backend portion 16 over a secure communications network 22 (e.g., secure vehicle-to-cloud (V2C) network). The secure communications network 22 may include a cellular-based network 24, a satellite-based network 26, a city-wide WiFi-based network, some other type of communications network and/or a combination thereof. Although only a few network vehicles 14 are shown in the drawings, it should be appreciated that system 10 may interact with a large fleet of vehicles that can include dozens, hundreds, thousands or even more vehicles. System 10 may be used with any vehicles, including (but not limited to) passenger, commercial and/or public transportation vehicles sold in any geographic area.

Backend portion 16 may include any suitable combination of software and/or hardware resources typically found in a backend of a cloud-based system, as best illustrated in FIG. 1. The backend portion 16 may be responsible for managing some of the programs and algorithms that run applications on the frontend portion 12, such as those that request, obtain and optionally analyze information of and from the network vehicles 14. It is noted that the data/information used to formulate recommendations may be analyzed by control systems 28 and processors on-board a network vehicle 14 or by the backend portion 16 or both, as desired. The backend portion 16 may be managed or controlled by the vehicle manufacturer and can be part of a larger cloud-based system that the vehicle manufacturer uses to communicate and interact with a large fleet of vehicles for a multitude of purposes. For example, the backend portion 16 may include or communicate with emergency alert systems, such as those that provide Amber alerts or other missing persons alerts, or law enforcement systems that may provide and receive information regarding vehicles of interest to them.

The backend portion 16 may include any suitable combination of software and/or hardware resources including, but not limited to, components, devices, computers, modules and/or systems such as those directed to applications, service, storage, management and/or security (each of these resources is referred to herein as a “backend resource,” which broadly includes any such resource located at the backend portion 16). In one example, the backend portion 16 has a number of backend resources including data storage systems 29, processors or servers 30, communication systems 32, programs and algorithms 34, as well as other suitable backend resources. It should be appreciated that backend portion 16 is not limited to any particular architecture, infrastructure or combination of elements, and that any suitable backend arrangement may be employed.

Frontend portion 12 may include any suitable combination of software and/or hardware resources typically found in a frontend of a cloud-based system, as shown in FIG. 2, and is generally responsible for sending information to the backend portion and receiving notifications, programs, instructions and the like from the backend portion 16. Depending on the particular arrangement, the frontend portion 12 may also be responsible for gathering camera, sensor, location and/or other data from devices on the vehicle 14 and sending such information to the backend portion 16. The frontend portion 12 is typically responsible for running the applications that interface with the users in the different vehicles 14, and for interfacing with the programs and algorithms 34 of the backend portion 16. The frontend portion 12 may also be managed or controlled by the vehicle manufacturer and can be part of a larger cloud-based system that the vehicle manufacturer uses to communicate and interact with a large fleet of vehicles for various purposes, as mentioned above. The frontend portion 12 may be distributed across one or more vehicles 14 and may include any suitable combination of software and/or hardware resources including, but not limited to, components, devices, computers, modules and/or systems (each of these resources is referred to herein as a “frontend resource,” which broadly includes any such resource located at the frontend portion 12).

In one example, the frontend portion 12 has a number of frontend resources including a vehicle control system 28 having one or more vehicle electronic module(s) installed in vehicles 14, which may include some combination of a data storage unit 38, an electronic control unit and/or processor(s) 40, applications 42, a communications unit 44 (e.g., one that includes a telematics unit and/or other communication devices with a receiver by which information is received at unit 44 and a transmitter by which information is sent from the unit 44), as well as other suitable frontend resources. The control system 28 may be or include a telematics box module (TBM), a telematics control module (TCM), a body control module (BCM), an electronic control unit (ECU), an infotainment control module, or any other suitable module known in the art. It is not necessary for the preceding units to be packaged in a single vehicle electronic module, as illustrated in FIG. 2; rather, they could be distributed among multiple vehicle electronic modules, they could be stand-alone units, they could be combined or integrated with other units or devices, or they could be provided according to some other configuration. It should be appreciated that frontend portion 12 is not limited to any particular architecture, infrastructure or combination of elements, and that any suitable frontend arrangement may be employed.

In order to perform the functions and desired processing set forth herein, as well as the computations therefore, the control system 28 may include, but is not limited to, one or more controller(s), control unit(s), processor(s), computer(s), DSP(s), memory, storage, register(s), timing, interrupt(s), communication interface(s), and input/output signal interfaces, and the like, as well as combinations comprising at least one of the foregoing, as generally described with regard to the frontend portion 12. For example, the control system 28 may include input signal processing and filtering to enable accurate sampling and conversion or acquisitions of such signals from communications interfaces and sensors. As used herein the terms control system 28 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 28 may be distributed among different vehicle modules, such as an infotainment system control module, engine control module or unit, powertrain control module, transmission control module, and the like, if desired, and the memory and one or more processors may be one or both integrated into the vehicle 14 or remotely located and wirelessly communicated to the vehicle 14, as desired.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device.

To control various functions of the vehicle 14, the vehicle control system 28, among other things, monitors and provides controls for operation of various vehicle systems. For example, the vehicle 14 may include drive by wire, brake by wire and steer by wire systems, or the drive, brake and steering systems may be mechanically linked, as desired, and the control system 28 may be programmed or include instructions to respond to driver action, such as movement of the throttle, and brake and steering inputs. The magnitude of the power output from the powertrain system and brake system varies as a function of the driver operation of the throttle and brake inputs 41, 43 (FIG. 3), as well as the instructions executed by the control system 28, which may vary in different circumstances and may be implemented in view of variables and by way of look-up tables, maps, algorithms and the like. Additionally, the magnitude of lateral accelerations may vary as a function of driver actuation of a steering input 45. And these systems may be operated partially or fully-autonomously, as desired.

To enable control and monitoring of various vehicle operating, environmental and other conditions related to vehicle operation, the control system 28 may include or be communicated with a range of sensors 46, shown diagrammatically in FIG. 3. By way of some examples, the vehicle 14 may include: a speed sensor that provides an indication of vehicle speed; one or more accelerometers responsive to vehicle accelerations in various directions and orientations; wheel speed sensors responsive to the rotational speed of the vehicle wheels; drive input sensors that sense the position and/or rate of movement of the throttle, brake and/or steering inputs; position or location sensors or devices (such as GPS or the like) to determine the location of the vehicle; temperature sensors for various things like ambient temperature, engine/motor temperature, and the like; fuel level sensor; battery sensor (voltage, charge level, or the like); an odometer; tire pressure sensors and other sensors that may be responsive to or useful in controlling vehicle operation (e.g. current draw of motors, torque sensors, steering sensors, etc). The vehicle may include object detection sensors like cameras, radar, lidar and other sensors, and these sensors may provide information about the vehicle and the surrounding environment. These sensors and data sources may provide dynamic vehicle data 52 or operating parameters and environmental information 54, shown as some of the information types in FIG. 8.

Various navigation programs 56 (FIG. 3) are known that compute a travel path to a destination, and convey information about the travel path to a driver in the form of visual and/or audible instructions for navigating the vehicle 14 along the travel path. The navigation programs can use information from the vehicle location sensor (e.g. GPS), a remote device location sensor (e.g. GPS chip of a smartphone in the vehicle) and map data and information relating to road conditions, speed limits, location of intersections and traffic signals, and the level of traffic (such as is available from Waze, GoogleMaps, TomTom maps, and other applications and sources). This information can be used to define travel paths that are shortest in total distance or time, or that avoid certain road types (e.g. not paved, toll roads, etc) or areas where travel time is less certain, for example, construction zones. The navigation programs 56 may be integrated into the vehicle control system 28 or infotainment system (which may be considered part of the control system), and/or can be resident on a remote or mobile device 62 that is connected to the vehicle 14 by wired or wireless connection.

Additional vehicle related data may include, by way of non-limiting examples, information about age and type of vehicle which may include information related to the size, weight and performance characteristics of the vehicle such acceleration, braking, steering, suspension characteristics. Diagnostics data, repair history data, recall information, warranty information, preferred or recommended maintenance schedules and information, and other information may also be provided for each vehicle. This may be called background vehicle data 58 (FIG. 8) and with the dynamic vehicle data 52 may be more generally be called vehicle data.

User data 60 may also be included in the information system 10. This information may include, by way of non-limiting examples, information about the owner or driver, including residence information, historical driving data, travel patterns like frequency of vehicle use, frequently visited locations, vehicle use by times of day and time of year, infotainment system usage, vehicle systems preferences and settings selected by the user, information about subscription services selected by the user, dealership or service center preference(s), and the like.

Further, user data 60 may include preferences of the user that may be input into the system 10 by the user, for example via an internet interface on the remote device 62 (e.g. phone, tablet, computer), or learned by the information system based upon user interaction with the vehicle and IVI system 18 over time, as noted later. The preferences can relate to, by way of non-limiting examples, fuel brands, restaurants, hotels, vehicle service centers, car accessory brands or type, music/entertainment/social media, hobbies, retail stores, stocks, sports teams, preference for paid or free services and applications, and other information. User data 60 may also include interaction information such as prior sales or purchase information, call center interactions, social media activity and other information.

Still further, user data may include preferences and settings regarding notifications that the user would like to receive or not. These preferences and settings enable a user to determine, for each program or app, which may include vehicle system programs (e.g. notifications regarding fuel level, tire pressures, etc) and apps added to the vehicle or remote device by the user (generally referred to as apps hereafter), specific conditions for when and how notifications should be sent to the user. A user might choose to have no notifications delivered from one or more apps, or to receive notifications only when the vehicle is not moving, or when the vehicle is moving below a threshold speed, or when the vehicle is on a certain type of road (and not other types of roads, for example), or only after the vehicle is stopped and placed into a park mode, or based on time of day, or to provide audio notifications or other hands-free operations, and so on.

Next, external data 64 may be provided to and used in the analysis by the information system 10. External data 64 may include, by way of non-limiting examples, mobility services, insurance information, lease and other financial data, data from other, similar vehicles, data from third parties (e.g. sales, promotions, general information), information about the terrain and environment, map data including information about the geography, businesses, road and the like, traffic information, status of orders or deliveries requested by the user, and the like.

In use, a wide range of notifications and communications may be provided to a vehicle and the occupants of the vehicle. The notifications may relate to, by way of non-limiting examples, vehicle systems (e.g. fuel level alerts, low battery alerts, engine/oil/battery temperature alerts, and other warnings or vehicle indicators, application notifications specific to individual applications accessed through the control system (e.g. the IVI system) or a device paired to the vehicle IVI or control system, a navigation system or program (e.g. for traffic, accident, construction or road conditions, and route instructions), a publicly broadcast notice (e.g. an AMBER or dangerous person alert), a weather alert (e.g. for severe weather), calendar alerts (e.g. reminders and appointment information) as well as notices from a device paired to the vehicle (e.g. a smart phone and the various notifications and alerts that occur with smart phone use).

The various notifications can be categorized or rated based on content, priority or importance, and the context for the notification. In at least some implementations, the system includes an importance level classifier, a content classifier and a context-aware prioritization model or classifier.

The importance level classifier (which may be part of a personalized learning and customer notification model) may be arranged to provide a base importance rating which may be a rating applied relative to one or more thresholds and on any desired scale. By way of non-limiting examples, the importance ratings may be numeric (e.g. 1 to 10) or tiered like maximum, high, default, low, minimum. The highest ratings may be given to critical notifications that should be delivered to a user regardless of the current driving situation, and the lower ratings may be given to notifications that can be delayed and delivered during a driving situation deemed appropriate for delivery of the notification, as noted herein.

In at least some implementations, the importance level classifier includes a gradient boosting matrix which may use a tree-based learning algorithm like LightGBM. This system can be efficient, readily scalable and suitable for large datasets. In at least some implementations, the mathematical model is represented by a sum of decision trees Fᵢ(x):

$$F ( x ) = {\sum }_{i = 1}^{M} {F}_{i} ( x )$$

where M is the number of trees used in the algorithm. Each tree Fᵢ(x) may be trained sequentially to correct the errors of the preceding trees, and build a robust system.

In at least some implementations, the rated importance of a notification can be adjusted based upon the context in which the notice is to be provided. For example, a notification that is deemed important and relevant to current conditions (e.g. real-time vehicle operating parameters) may have an adjusted importance rating that is greater than the base importance rating, and greater than an adjusted rating in instances in which the same notice is less relevant or not relevant to the current conditions. Thus, notifications may have a base rating and one or more condition specific ratings that are dynamically adjusted by the system. This can enable the system to avoid distracting a driver with a less important notification during a higher stress driving situation that is occurring now or is likely to occur in the near-term (e.g. within a threshold time period, that may be adjustable). The less important notification can then be delivered when the driving situation changes to an appropriate level.

In at least some implementations, the content classifier may categorize notifications by their content. Representative and non-limiting examples of categories for notifications may include, greetings, compliments, social media notices, management notices, speed limit indications or warnings, hard braking warnings, warnings about phone use while driving, weather or traffic warnings, emergency warnings, promotion notices, notifications that require a responsive action or no responsive action, and so on.

In at least some implementations, the content classifier may include a gradient boosting matrix which may use a tree-based learning algorithm like LightGBM, to classify the notifications into multiple categories. The content classifications and importance ratings can be combined into a matrix of model, with an importance level determined for each of the content classifications, if desired. In this way, the same rules may be applied for all notifications in a category so similarly categorized notifications are managed in the same way, in at least some implementations.

The mathematical model for multi-class classification may be done by extending a binary classification model to handle multiple classes. In an example in which fₖ(x) is the predicted probability that the notification belongs to class k, where k ranges over all content categories, the final predicted class is then the one with the highest probability, from the following model, in which K is the total number of content categories:

$$P ( y = k \vert x = \frac{exp ( {f}_{k} ( x ) )}{{\sum }_{j = 1}^{K} exp ( {f}_{k} ( x ) )}$$

Next, the context-aware prioritization model can be used to dynamically adjust the importance rating of different notifications, recognizing that certain notifications are more relevant and/or important in some situations than other situations. This may be done by content classification, for each individual notification type or both, as desired. For example, weather-based notifications can be very relevant to only vehicles in or traveling near the area for which the notification is issued, and may have little or no importance to other vehicles. Similarly, traffic condition notifications for areas that a vehicle has already passed through may have little or no importance to that vehicle, but may be very relevant to vehicles traveling toward the area for which the traffic notification is to be issued. In addition to location-based relevance, time may be considered where some notifications like restaurant promotions or the like may be more relevant during times when people normally eat meals than at other times.

In at least some implementations, the system may consider and receive data regarding a number of context features. For example, representative but non-limiting context features include: driving patterns like vehicle speed, acceleration, deceleration, and other driving behavior features; time of day or date or month and the like; location like exact vehicle location obtained via GPS or area or region in which the vehicle is used; current weather and traffic conditions; user preferences by which a user can determine what notifications they want/need and priority levels for the notifications including context specific priority levels.

In at least some implementations, the context-aware prioritization model uses one or both of a rule-based approach and a reinforcement learning approach. For a rule-based approach, mathematical models involve defining a set of rules that dictate how the priority or importance should be adjusted based on various contextual features. For example, Adjusted Priority=Base Priority+Weather Rule+Traffic Rule+Location Rule+Time Rule+ . . . . With this approach, one or more rules may be established for various factors, and then those factors may be utilized to adjust the priority or importance rating as a function of the current conditions for the vehicle, that is, the current context of the vehicle.

For a reinforcement learning approach, the model involves defining a reward function that guides the learning process, where model may include determining an estimated value of taking a first action in a first state and then compare the estimated value to the reward that occurs from taking the first action in the first state. The mathematical model includes the definition of state representations, actions, and the reward function. For example:

$$Q ( s , a ) ← Q ( s , a ) + α \cdot ( R ( s , a ) + γ \cdot {max}_{{a}^{′}} Q ( {s}^{′} , {a}^{′} ) - Q ( s , a ) )$$

Where:
Q(s, a) is the estimated value of taking action a in state s,
R(s, a) is the immediate reward of taking action a in state s,
α is the learning rate,
γ is the discount factor, and
s′ is the next state.

Collectively, the various algorithms and mathematical formulas and analyses noted herein may be part of the personalized learning and customer notification model. The model may provide a comprehensive solution to notification analysis and management of the notifications.

User interaction with the notification management system can occur via a remote device (e.g. phone, tablet, computer and via an internet interface) or the IVI system 18, and in particular, a head-unit or main console thereof which may include one or more display screens 20 and the user interface 21. The user interface 21 may include one or more inputs that may be provided in one or more forms, such as but not limited to, touch responsive portions of a display, one or more manually actuated inputs (e.g. dials, buttons or switches), and/or audio inputs including a microphone via which verbal inputs can be given by a user.

The IVI system 18 may display various items and options that may be selected by a user. By way of some non-limiting examples, the items and options may include menu options of vehicle settings and preference menus (for control of heating and cooling options, audio video settings and preferences, door lock functionality, performance settings (sport, eco, etc) and various other settings), program icons displayed for included or embedded apps that may be selected by a user and run by the system, such as via a web portal or application programming interface (API). As noted herein, the system may include programs or “apps” or “web widgets” that may relate to a wide range of tasks and features, such as but not limited to, navigation, audio/video, social media, interaction with paired devices, text messaging, phone use, shopping, restaurants, reviews (e.g. Yelp), and an app store via which apps may be downloaded or updated.

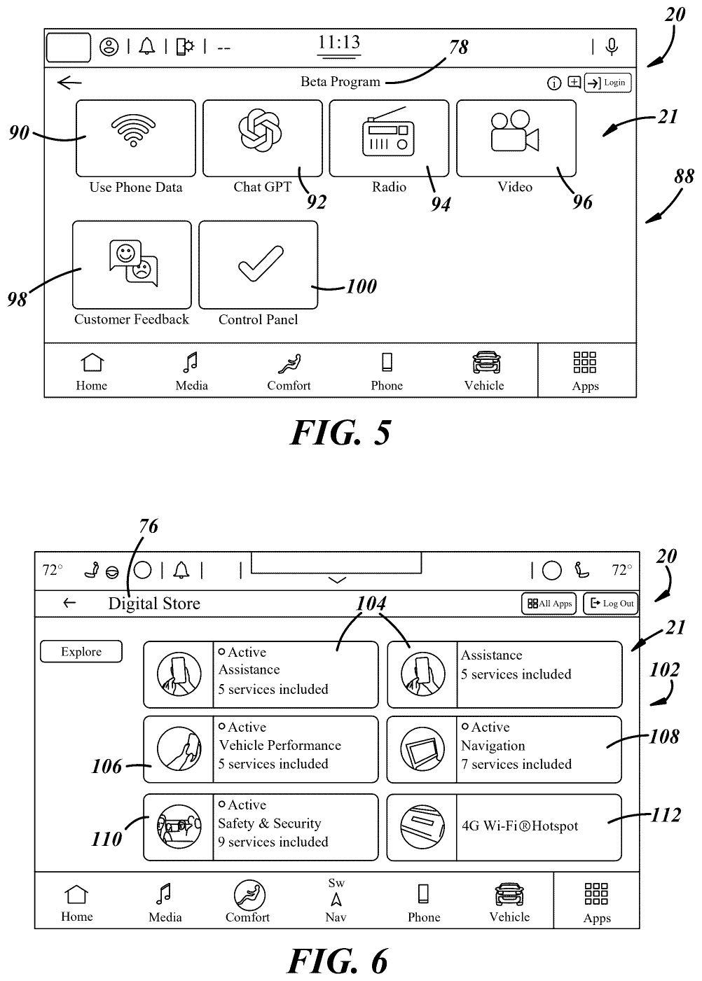

FIG. 4 shows a screenshot 75 for a representative display 20 including icons for a Digital Store 74, Beta Program 76, Geo Caching 78, Iconic Games 80, RevKit 82 and a Yelp™ app 84. FIG. 5 shows a screenshot 88 for the Beta Program 76 which includes options to use phone data for an internet connection 90, ChatGPT 92, Radio 94, Video 96, Customer Feedback 98 and Control Panel 100. FIG. 6 shows a screenshot 102 for the Digital Store app 76, with menu options for vehicle service and option subscriptions and related interfaces therefore, examples include Assistance 104, Vehicle Performance 106, Navigation 108, Safety and Security 110, and WiFi Hotspot 112 use. These items may include submenus and further information on additional screens, in a known manner. In this way, the IVI system 18 may be used to manage subscriptions to various programs, features or options, and permit use of at least some such programs, features or options. Further, one or more of these apps and menu options may include notifications, for example, as to the status of a feature or option or subscription, promotional offers, need to download updated apps, similar apps that may be of interest or useful, and so on. These notifications may be managed by the systems and methods described herein so that they are prioritized and provided in an appropriate manner to a user.

The control system 28 may provide information to the backend portion 16 and receive information from the backend portion 16. Some of the information received from the backend portion 16 may include notifications 72 or other messages to be displayed to a user via the IVI system 18, or a paired device. The notifications 72 may be generated as noted herein, including as a function of real-time or current user and vehicle context features, including real-time or near-term vehicle operating parameters.

In at least some implementations, the vehicles 14 may transmit data/information during operation, at certain intervals or in a stream that may occur continuously during vehicle operation and not just upon occurrence of an initiating event that causes the control system 28 to initiate a transmission. Thus, the vehicles 14/control systems 28 can be programmed to transmit data in the ordinary course of vehicle use and regarding numerous vehicle operating parameters. The data can be captured or logged by the backend portion 16 and some analysis conducted. When the status of different vehicle features or systems changes (e.g. on/off or activated/deactivated or activated and adjusted), the data provided from the vehicle 14 may include the numerous vehicle operating parameters and also data indicative of the feature or system status change. The backend portion 16 may then determine occurrence of the feature or system status change and execute methods or programs in accordance with predetermined programs or instructions. The data may be transmitted in any desired format, and for efficiency of computational resources, may be provided in a binary code stream from the vehicle 14 to the backend portion 16, and the backend portion 16 may include programming to decipher/interpret the binary code.

When one or more conditions are met, the backend portion 16 may communicate information, which may include one or more notifications 72, to one or more vehicles 14 for which the notifications are determined to be relevant. The notifications can be provided to the vehicle 14 for presentation to or review by a vehicle occupant in any desired way. The notice can be provided on a vehicle display 20, such as in a pop-up window including text, graphic(s), animation(s), etc., in an audio file played by the vehicle infotainment system 18, or provided to a remote device that is paired or otherwise connected to the vehicle control system 28 for audible or visual presentation, or by some combination of these non-limiting examples.

The models and algorithms may be trained with initial data sets and updated continuously or as desired, as additional information is provided in the system and as feedback about past notifications and management thereof are factored into the models to improve the relevance and accuracy of future notifications. In this way, the system can provide context relevant notifications to each user of the system based on user specific preferences or settings and current/real-time data. The analyses and data and model refinement may be done by the backend portion, data transmission to and from the backend portion may be done seamlessly to the users, and the notifications can be provided in a convenient way via the IVI system 18, and, in at least some implementations, with an integrated web interface of the IVI system 18 that enables a wide range of options and features for users.

The notification management system can collect and analyze data from the vehicle's sensors and in-vehicle web apps, considering factors such as driving speed, location, traffic conditions, and the content of notifications from web apps, the vehicle and other sources. Certain driving conditions require greater attention from a driver and so less distractions can be tolerated under those conditions. For example, driving at higher speed or with greater accelerations, or in adverse weather, or in darkness or in traffic or in an area requiring changes in speed or direction (e.g. highway on-ramps or off-ramps, or near road intersections) can require more of the driver's attention. In these and other situations, reduced distractions can be helpful to the driver to safely and effectively operate the vehicle. To prevent or reduce notifications, the system intelligently prioritizes notifications based on real-time driving patterns, ensuring that critical notifications take precedence while non-urgent notifications are appropriately delayed or muted. With the context-aware prioritization of notifications, the system employs adaptive distraction management techniques to adjust the presentation and timing of notifications and web app interactions to maintain a balance between user engagement and driver/vehicle safety.

To improve user satisfaction with the system, users can create personalized profiles that not only specify notification preferences but also include preferences for in-vehicle web apps usage, defining which apps and/or notifications are allowed or restricted during certain driving conditions. For example, certain apps may be restricted when the vehicle is in motion or limited to hands-free interactions to enhance safety. With machine learning algorithms, the system can learn from user behavior and driving patterns over time, and continuously refine the rules by which notifications are provided to a user. Finally, the system can be seamlessly integrated with the vehicle's infotainment systems, ensuring a cohesive and user-friendly experience for users.

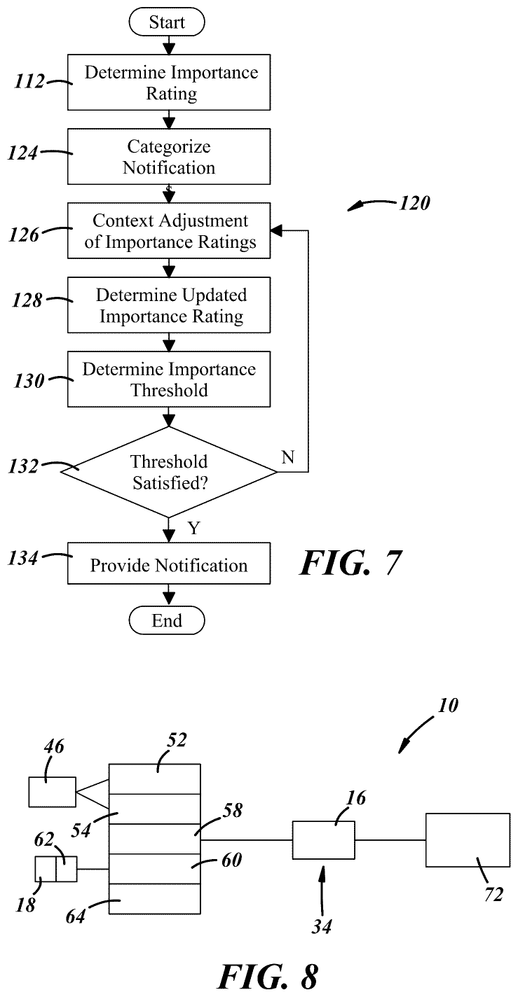

In at least some implementations, as generally shown in FIG. 7, a method 120 for determining priority or importance of a notification with regard, to the current user/vehicle context includes: a) in step 122 determining an importance rating or level (e.g. a base importance rating) of a notification; b) in step 124, determining a content category of the notification; c) in step 126, adjusting the importance rating or level based on current user/vehicle context features; and d) in step 128, determining a final importance rating or level based on the adjusted importance rating or level and the content category. For example, weather related notifications can be given a higher importance level when the user/vehicle context includes indications of adverse weather conditions (e.g. conditions that affect control of the vehicle) than when the user/vehicle context includes indications of good weather conditions for driving. By way of another non-limiting example, traffic related notifications can be given a higher importance level the closer a vehicle is to the area including the traffic condition of the notification, and so on.

The method may also include, in step 130, determining an importance threshold based on at least part of the context relevant information. After that, in step 132, the method may include comparing the updated/final importance rating determined in step 128 to the importance threshold. If the importance rating of a notification meets or satisfies the importance threshold, then, in step 134, the notification is provided to the user. If the importance rating of a notification does not meet or satisfy the importance threshold, the notification is not provided to the user and the method may return to step 126 for review of the adjusted importance rating and the importance threshold to determine if the context has changed such that the notification can be provided at a later time.

In this way, when a higher importance threshold is set, because of current contextual information, only notifications that meet the higher threshold will be provided to the vehicle, or displayed within the vehicle. The decision whether to provide the notification can be made at the backend portion (e.g. the notification is not sent from the backend portion to the front end portion if the threshold is not satisfied) or at the frontend portion (e.g. the notification is sent from the backend portion to the front end portion but the frontend portion does not communicate the notification to the user if the threshold is not satisfied).

The various method steps and models may be carried out in a different order, and steps may be repeated one or more times, at different times, during performance of the method. For example, the rating, categorizing and other algorithm analyses can be done at different times for the same or different data sets and types of information, as desired.

What is claimed is:

1. A method for managing notifications to a user, comprising:
receiving at a backend portion information relating to multiple notifications;
determining a base importance rating for one or more of the multiple notifications;
categorizing the notifications into multiple content classes based at least in part on the content of the notifications;
receiving at the backend portion context relevant information;
determining an adjusted importance rating for the one or more of the multiple notifications as a function of the base importance rating, class and context relevant information; and
providing a notification from the backend portion when the adjusted importance rating satisfies an importance threshold that is based on at least part of the context relevant information.

2. The method of claim 1 wherein the base importance rating includes multiple levels of importance by which a relative importance of different ones of the multiple notifications can be determined.

3. The method of claim 1 wherein the adjusted importance rating includes multiple levels of importance by which a relative importance of different ones of the multiple notifications can be determined.

4. The method of claim 1 wherein the context relevant information includes one or more of current vehicle operating conditions, vehicle location, weather at or near the vehicle location, time and one or more user preferences.

5. The method of claim 4 wherein the current vehicle operating conditions includes one or more of a vehicle speed, acceleration and type of road on which the vehicle is located.

6. The method of claim 5 wherein the current vehicle operating conditions includes data from one or more vehicle sensors.

7. The method of claim 1 which also includes receiving at the backend portion information about one or more environmental conditions.

8. The method of claim 1 wherein the importance rating is determined with a gradient boosting matrix.

9. The method of claim 1 wherein the categorizing step is accomplished with a gradient boosting matrix.

10. The method of claim 1 wherein the adjusted importance rating is determined with a rules-based model that changes the base importance rating in accordance with rules for multiple variables. and a reinforcement learning model.

11. The method of claim 1 wherein the adjusted importance rating is determined with a reinforcement learning model that defines a reward function and based at least in part on an estimated value of taking a first action in a first state compared to the reward from taking the first action in the first state.

12. A system of a vehicle for managing notifications to a user of the vehicle, comprising:
one or more vehicle sensors;
a control system that includes a data storage unit and an electronic control unit, the control system being in communication with the one or more vehicle sensors;
a communications unit that is communicated with the control system and that has a receiver by which information is received at a network vehicle and a transmitter by which information is transmitted from the network vehicle; and
a backend portion of a cloud-based system, wherein the backend portion includes a processor and memory with programming to:
receive at a backend portion information relating to multiple notifications;
determine a base importance rating for one or more of the multiple notifications;
categorize the notifications into multiple content classes based at least in part on the content of the notifications;
receive at the backend portion context relevant information;
determine an adjusted importance rating for the one or more of the multiple notifications as a function of the base importance rating, class and context relevant information;
determine an importance threshold based on at least part of the context relevant information; and
provide a notification from the backend portion when the adjusted importance rating satisfies the importance threshold.

13. The system of claim 12 wherein the context relevant information includes one or more of current vehicle operating conditions, vehicle location, weather at or near the vehicle location, time and one or more user preferences.

14. The system of claim 13 wherein the current vehicle operating conditions includes one or more of a vehicle speed, acceleration and type of road on which the vehicle is located.

15. The system of claim 14 wherein the current vehicle operating conditions includes data from one or more vehicle sensors.

16. The system of claim 12 which also includes receiving at the backend portion information about one or more environmental conditions.

17. The system of claim 12 wherein the importance rating is determined with a gradient boosting matrix.

18. The system of claim 12 wherein the categorizing step is accomplished with a gradient boosting matrix.

19. The system of claim 12 wherein the adjusted importance rating is determined with a rules-based model that changes the base importance rating in accordance with rules for multiple variables, and a reinforcement learning model.

20. The system of claim 12 wherein the adjusted importance rating is determined with a reinforcement learning model that defines a reward function and based at least in part on an estimated value of taking a first action in a first state compared to the reward from taking the first action in the first state.
